(19) United States
(12) Patent Application Publication
(10) Pub. No.: US 2017/0177597 A1
(43) Pub. Date: Jun. 22, 2017

(54) BIOLOGICAL DATA SYSTEMS

(71) Applicant: DNANEXUS, INC., Mountain View, CA (US)

(72) Inventor: George ASIMENOS, Mountain View, CA (US)

(21) Appl. No.: 15/386,729

(22) Filed: Dec. 21, 2016

Related U.S. Application Data
(60) Provisional application No. 62/271,204, filed on Dec. 22, 2015.

(51) Int. Cl. G06F 17/30; G06F 19/28

(52) U.S. Cl. CPC G06F 17/30091; G06F 19/28; G06F 17/30115; G06F 17/30233

(57) ABSTRACT

Disclosed herein are systems and methods for processing data, particularly biological data. An exemplary system comprises a memory and a processor coupled to the memory, wherein the memory comprises program instructions executable by the processor to: write into the memory a first index comprising one or more locations of a genomic sequence file comprising a header and genomic sequence data; calculate, based on the first index and a genomic range, a byte range of the genomic sequence file; write into the memory a portion of the genomic sequence file, wherein the portion comprises genomic sequence data located within the byte range; calculate a second index; and write into the memory the second index, wherein the genomic sequence data are compressed and no portion of the genomic sequence data is decompressed.

### CROSS-REFERENCE TO RELATED APPLICATIONS

This application claims priority to U.S. Provisional Patent Application No. 62/271,204 filed Dec. 22, 2015, the disclosure of which is hereby incorporated by reference in its entirety for all purposes.

### BACKGROUND

In order to achieve high confidence in calling bases in genomic sequencing applications, second generation genome sequencing machines sequence each base of a subject sample multiple times. This is achieved by synthesis of a large number of nucleic acid reads covering the various portions of the sample. The average number of reads generated for each base can be as high as 30 or more using current genome sequencers, resulting in a large amount of data when sequencing genomes such as the human genome, which contains more than 3 billion base pairs. Researchers wishing to process such large amounts of read data confront limitations posed by available computing resources. These and other challenges are addressed by the systems and processes described herein.

### BRIEF DESCRIPTION OF THE DRAWINGS

FIG. 1 shows a diagram of an exemplary computer that may be used to construct a system for executing the processes described herein.

FIG. 2 shows a diagram of an exemplary system for performing the methods described herein.

FIG. 3 shows a schematic of the data of interest.

FIG. 4 depicts a flow diagram of a method for processing data.

FIG. 5 shows various elements of the systems and processes described herein.

FIG. 6 shows results of an experiment.

### DETAILED DESCRIPTION

Next-generation or second-generation sequencing devices, such as the HiSeq X Ten, employ massively parallel sequencing chemistry, creating millions of fragments of DNA against a template DNA sequence derived from a biological sample of interest. Researchers have developed computational methods to align these fragments, known as reads, against a reference DNA sequence. Variations found in the aligned reads, or alignments, in comparison to the reference DNA sequence are identified for further downstream analysis.

Raw reads generated by a sequencing device (or optionally a preprocessed version of the reads) can be aligned against a reference sequence using an alignment program. For example, Illumina sequencing devices can produce a bcl basecall file, which may be aligned directly by ISAAC aligner software, or can be converted into a fastq file, which is then aligned by software such as ISAAC aligner or BWA and Sambamba. The resulting file contains alignments, which are reads that have been matched to positions in a reference sequence.

One common alignment file format is the SAM file. See Sequence Alignment/Map Format Specification by the SAM/BAM Format Specification Working Group. Because of their large size, SAM files will often be compressed to produce a BAM file. Even as a compressed format, BAM files may still be large. In order to facilitate use of a BAM file in later computational applications, BAM files are often used in conjunction with a file index, such as a BAI file. A file index in this context contains information that allows random access of a compressed file. BAI files can be used to quickly retrieve alignments overlapping a specified region of a sequence without going through all of the alignments contained in the BAM file. Existing methods of using a BAI and BAM file for retrieving alignments typically include a step of decompressing some portion of the BAM file. It may be advantageous in some applications to avoid decompression of a file containing genomic sequence data, such as a BAM file, since decompressing and recompressing parts of the file incur costs in time and consumption of computing resources.

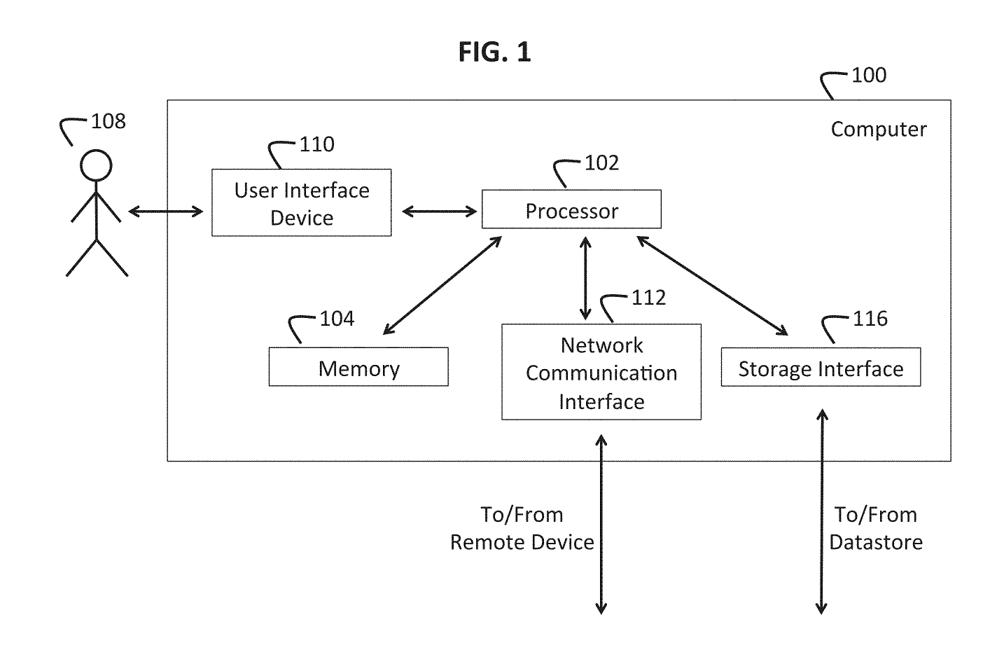

FIG. 1 is a block diagram of an exemplary computer or computing system 100 that may be used to construct a system for executing the processes described herein. Computer 100 includes a processor 102 for executing instructions. The processor 102 represents one processor or a multiprocessor system including several processors (e.g., two, four, eight, or another suitable number). Processor 102 may include any suitable processor capable of executing instructions. For example, in various embodiments processor 102 may be general-purpose or embedded processors implementing any of a variety of instruction set architectures (ISAs), such as the x86, PowerPC, SPARC, or MIPS ISAs, or any other suitable ISA. In multiprocessor systems, each of processors may commonly, but not necessarily, implement the same ISA. In some embodiments, executable instructions are stored in a memory 104, which is accessible by and coupled to the processor 102. Memory 104 is any device allowing information, such as executable instructions and/or other data, to be stored and retrieved. A memory may be volatile memory, nonvolatile memory or a combination of one or more volatile and one or more nonvolatile memory. Thus, the memory 104 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Computer 100 may, in some embodiments, include a user interface device 110 for receiving data from or presenting data to user 108. User 108 may interact indirectly with computer 100 via another computer. User interface device 110 may include, for example, a keyboard, a pointing device, a mouse, a stylus, a touch sensitive panel (e.g., a touch pad or a touch screen), a gyroscope, an accelerometer, a position detector, an audio input device or any combination thereof. In some embodiments, user interface device 110 receives data from user 108, while another device (e.g., a presentation device) presents data to user 108. In other embodiments, user interface device 110 has a single component, such as a touch screen, that both outputs data to and receives data from user 108. In such embodiments, user interface device 110 operates as a component or presentation device for presenting or conveying information to user 108. For example, user interface device 110 may include, without limitation, a display device (e.g., a liquid crystal display (LCD), organic light emitting diode (OLED) display, or electronic ink display), an audio output device (e.g., a speaker or headphones) or both. In some embodiments, user interface device 110 includes an output adapter, such as a video adapter, an audio adapter or both. An output adapter is operatively coupled to processor 102 and configured to be operatively coupled to an output device, such as a display device or an audio output device.

Computer 100 includes a storage interface 116 that enables computer 100 to communicate with one or more of data stores, which store virtual disk images, software applications, or any other data suitable for use with the systems and processes described herein. In exemplary embodiments, storage interface 116 couples computer 100 to a storage area network (SAN) (e.g., a Fibre Channel network), a network-attached storage (NAS) system (e.g., via a packet network) or both. The storage interface 116 may be integrated with network communication interface 112.

Computer 100 also includes a network communication interface 112, which enables computer 100 to communicate with a remote device (e.g., another computer) via a communication medium, such as a wired or wireless packet network. For example, computer 100 may transmit or receive data via network communication interface 112. User interface device 110 or network communication interface 112 may be referred to collectively as an input interface and may be configured to receive information from user 108. Any server, compute node, controller or object store (or storage, used interchangeably) described herein may be implemented as one or more computers (whether local or remote). Object stores include memory for storing and accessing data. One or more computers or computing systems 100 can be used to execute program instructions to perform any of the methods and operations described herein. Thus, in some embodiments, a system comprises a memory and a processor coupled to the memory, wherein the memory comprises program instructions executable by the processor to perform any of the methods and operations described herein.

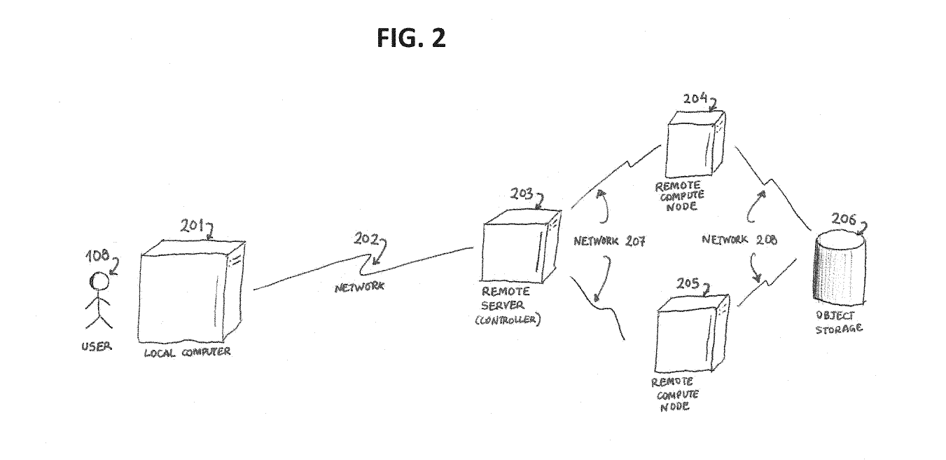

FIG. 2 shows a diagram of an exemplary system for performing the steps, operations and methods described herein. From the point of view of user 108, the user interacts with one or more local computers 201 in communication with one or more remote servers (controllers) 203 by way of one or more networks 202. User 108, via his or her local computers 201, instructs controllers 203 to initiate processing. The remote controllers 203 may themselves be in communication with each other through one or more networks 202 and may be further connected to one or more remote compute nodes 204/205, also via one or more networks 207. Controllers 203 provision one or more compute nodes 204/205 to process the data, such as genomic sequence data. Remote compute nodes 204/205 may be connected to one or more object storage 206 via one or more networks 208. The data, such as genomic sequence data, may be stored in object storage 206. In some embodiments, one or more networks shown in FIG. 2 overlap. In some embodiments, the user interacts with one or more local computers in communication with one or more remote computers by way of one or more networks. The remote computers may themselves be in communication with each other through the one or more networks. In some embodiments, a subset of local computers is organized as a cluster or a cloud as understood in the art. In some embodiments, some or all of the remote computers are organized as a cluster or a cloud. In some embodiments, a user interacts with a local computer in communication with a cluster or a cloud via a one or more networks. In some embodiments, a user interacts with a local computer in communication with a remote computer via one or more networks. In some embodiments, a file, such as a genomic sequence file or an index, is stored in an object store, for example, in a local or remote computer (such as a cloud).

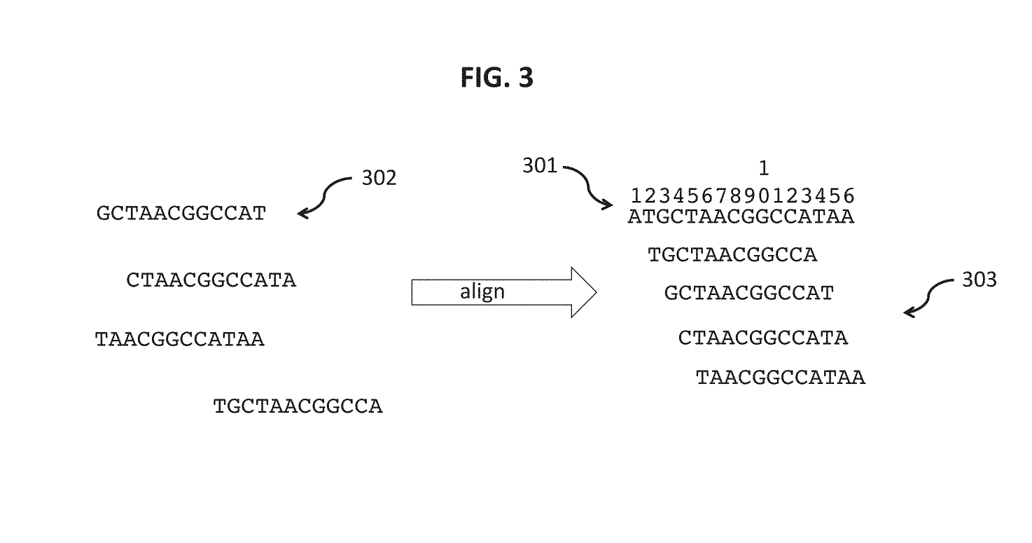

FIG. 3 shows a schematic of the data of interest. A reference sequence 301 contains a known sequence of characters, each numbered serially to provide a position or location within the sequence. The characters can be any data, biological data being of particular interest. In exemplary embodiments, the characters of a reference sequence refer to genomic data or genomic sequence data, such as the various nucleic acids that compose DNA or RNA. A sequencing device receives a sample containing genetic material and generates a collection of short strings of nucleic acids, referred to as reads 302. Any of a whole host of algorithms and software known in the art can be used to match or align the reads against a reference sequence. Examples include BBMap, BigBWA, Bowtie, BWA, CUSHAW, GEM, iSAAC, Novoalign, SOAP and Stampy. These algorithms determine the best or likely location within a reference sequence where some, most or all of the nucleic acids of a read match or align with the nucleic acids of the reference sequence or of the reverse complement of the reference sequence. One of skill in the art will appreciate that a read may be determined to match even in the presence of nucleic acid insertions, deletions or substitutions in either the reference sequence, the read or both. Alignment algorithms thus output at least a position in the reference sequence where a read is matched. Reads that have been associated or matched with some position in a reference sequence can be referred to as mapped reads or alignments 303.

Genomic sequence files contain the genomic sequence data described herein, as well as other information. A genomic sequence file can comprise data on a plurality of alignments against one or more reference sequences. In exemplary embodiments, reads, positions and optional information, such as read quality, are arranged in some logical manner in a genomic sequence file. For example, the SAM and BAM formats may contain sorted alignments by reference ID and then the leftmost position coordinate of the alignment. SAM and BAM files, as well as other types of genomic sequence files, also may include header data, which may include format version, reference sequence names and lengths and other identifiers. Genomic sequence files can also include an end-of-file (EOF) string or marker, which is a series of data that is interpreted to indicate the end of the file. In BAM files, the end-of-file marker is 28 bytes. Thus, genomic sequence files can contain various combinations of a header, genomic sequence data and end-of-file marker.

Because of the large number alignments that may be needed for certain applications, it may be useful to compress files containing such alignments in order to conserve storage resources. Any of a number of compression algorithms known in the art may be used for such purpose. In exemplary embodiments, BGZF block compression is used, for example, to generate a BAM file from a SAM file. In those embodiments, sequential blocks of a SAM file are bgzipped into compressed BGZF blocks. Using BGZF block compression, the blocks before and after compression do not exceed 64 kB (65,536 bytes). BAM files are thus a concatenation of BGZF blocks. Through the use of a file index (sometimes referred to simply as an index), a compressed file can be randomly accessed at various points throughout the compressed file in order to grab certain portions of the data. It is noted that the maximum size of a compressed block of data can be no greater than the maximum size of the same block uncompressed.

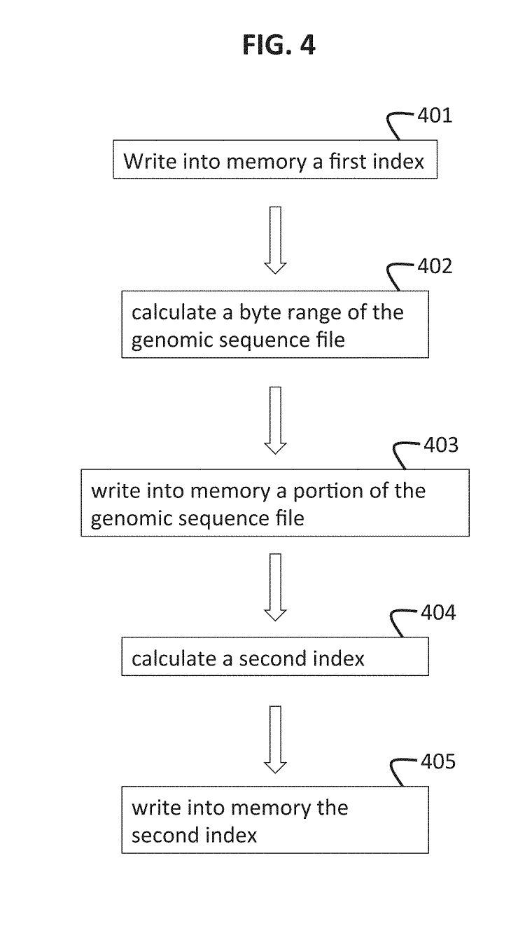

FIG. 4 depicts a flow diagram of a method for processing data. In exemplary embodiments, these data are genomic sequence data (for example, reads or alignments) contained in a genomic sequence file, such as those described herein (in particular, a BAM file). In exemplary embodiments, the genomic sequence file comprises a header and genomic sequence data. In some embodiments, the genomic sequence file comprises a header, genomic sequence data and an end-of-file marker. In exemplary embodiments, the genomic sequence file is compressed and no portion thereof is decompressed in performing the processes described herein, such as in FIG. 4. In exemplary embodiments, genomic sequence data are compressed and no portion thereof is decompressed in performing the processes described herein, such as in FIG. 4.

In block 401, a first index is written into memory. The first index generally contains data referring to locations in a compressed genomic sequence file where an alignment or chunks of alignments can be found. A chunk is a set of compressed alignments whose size is based on a predetermined amount of memory in which the uncompressed data fit. The locations in the first index may be given as a virtual file offset, an integer in which one portion refers to a byte offset into the compressed file to the beginning of a compressed block and another portion that refers to a byte offset into the data stream of such uncompressed block. For example, a virtual file offset could be a 32-bit unsigned integer in which the leftmost 16 bits refer to a byte offset into the compressed file to the beginning of a compressed block and the rightmost 16 bits refers to the byte offset into the data stream of the uncompressed block. The first index may also contain other data, such as bins, to facilitate indexing and fast retrieval. Alignments can be grouped into or associated with such bins and arranged or ordered in the file index accordingly. Thus, a first index may contain data on one or more reference sequences, each divided into bins, which themselves contain alignments. In exemplary embodiments, the file index is a BAI file. In the general arrangement of a BAI file, a magic string is followed by a number of reference sequences, each of which has a number of bins, which of which contains a number of chunks, each of which is characterized by a beginning virtual file offset and an end virtual file offset representing the start and end of the chunk respectively. For each reference sequence, following the chunks is a set of virtual file offsets each of which represents the first alignment in a series of 16 kbp intervals across the reference sequence, thus forming a linear index. The BAI file optionally ends with an integer representing the number of unplaced unmapped reads. In some embodiments, a first index is written into nonvolatile memory.

In some embodiments, a URL is used to access the contents of a file, such as the first index. In these embodiments, the file is located on a computer remote from the local computer that is used to analyze or store some or all of contents of the file. The remote computer in some instances may store the file in an object store. In exemplary embodiments, a URL to the first index is written into memory. In some embodiments, the first index accessed at the URL is written into memory.

Before retrieving the data from a remote computer, it may be useful to calculate the amount of space needed locally and to preallocate memory before writing the data. The preallocated memory can be calculated with high precision in order minimize the amount of preallocated memory that does not have data written to it. That is, it is possible to calculate down to a single byte the amount of memory that needs to be preallocated. For a remote file accessed by the HTTP protocol, this calculation could comprise making an HTTP head request. Thus, in some embodiments, memory is preallocated for the first index.

Asynchronous I/O methods can optionally be used to quickly retrieve data from any file stored remotely. In exemplary embodiments, a first index is loaded into memory by asynchronous I/O. The use of asynchronous I/O allows the program's execution to continue while data is being transmitted. To read or write from a network connection, the program performs non-blocking read or write system calls to the kernel, and monitors all pending operations using a single polling call to the kernel. During the time that no read or write requests can be fulfilled, the program is free to perform other processing tasks. A number of different asynchronous I/O libraries are widely available for this purpose. For example, libuv is a multiplatform support library designed around an event-driven asynchronous I/O model. With asynchronous I/O, a plurality of simultaneous connections between a local computer and a remote computing is utilized to transfer data between the computers.

In block 402, a byte range of the genomic sequence file is calculated. Here, the byte range is determined based on the data contained in the first index and a genomic range selected and input by the user. The genomic range is a coordinate range (such as one or more identification or index numbers) referring to one or more reference sequences. The reference sequence can represent any structure of interest, in particular a biological structure such as a chromosome. In some embodiments, the genomic range consists of whole contiguous reference sequences. A whole contiguous reference sequence is one that has not been divided further. Calculating the byte range of the genomic sequence file may be done by a processor.

For each reference sequence in the genomic range, the bins into which the reference sequence have been divided can be traversed to determine the lowest and highest virtual file offsets of the chunks contained within the bins. Bins that contain metadata and not any actual sequences (i.e., pseudobins) may be ignored. The lowest and highest virtual file offsets of the aggregate of these chunks determine the region of the genomic sequence file containing the alignment data of interest to the user.

In the case where the lowest virtual file offset is not found and the genomic sequence file is smaller than or equal to the maximum size of a compression block plus an end-of-file string, the entire genomic sequence file is retrieved. In the case where the lowest virtual file offset is not found and the genomic sequence file is smaller than the maximum size of a compression block plus an end-of-file string, at least the first compression block is retrieved (by retrieving the maximum compression block size starting at the beginning of the file) along with the end-of-file string. Because the contents of an end-of-file string may be known in advance, in some instances, instead of retrieving the end-of-file string, such string may be simply appended to retrieved data.

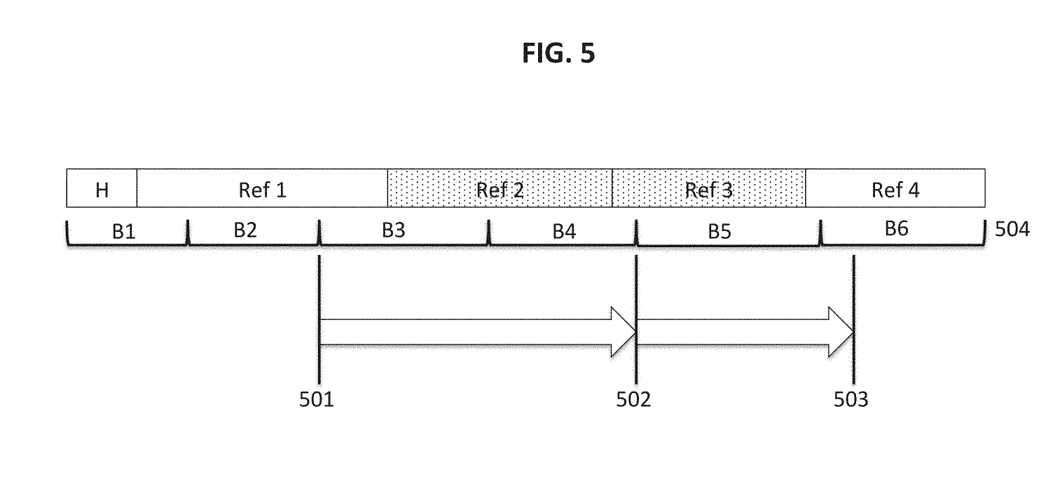

Referring to FIG. 5 in which reference sequences 2 and 3 is the genomic range chosen, where the lowest virtual file offset has been found, such “low position” 501 indicates the beginning of the first compressed block of the genomic sequence file 504 to retrieve. The highest virtual file offset is a “high position” 502 indicating the beginning of the last compressed block of the genomic sequence file to retrieve. Because each of the compressed blocks of a genomic sequence file may be of varying sizes, the location of the end of the last compressed block to be retrieved is not known. Thus, the maximum size of a compressed block of data is added to the high position resulting in a new high position 503 that is used to determine the end point of the length of data to retrieve from the genomic sequence file. If the new high position is greater than the size of the genomic sequence file less one plus the EOF marker, then the high position is simply set to the end of the genomic sequence file.

In exemplary embodiments, the header of the genomic sequence file is written into memory. Since the header is located at the beginning of the genomic sequence file, in these embodiments, at least the first compressed block is retrieved by retrieving the maximum size of a compressed block starting from the beginning of the genomic sequence file. If the location of the low position is less than or equal to the maximum size of a compressed block, then the low position is reset to the beginning of the genomic sequence file (zero). If the location of the low position is greater than the maximum size of a compressed block, then a “first-block offset” between the end of the first block retrieved and the low position is determined and stored for later use. In some embodiments, the header of the genomic sequence file is written into nonvolatile memory.

The length between the low and high position may then be divided into a set of intervals by which portions of the genomic sequence file are retrieved. In some embodiments, the EOF of the genomic sequence file is retrieved. In those embodiments, an additional interval equal to the length of the EOF is appended to the intervals. In some embodiments, the EOF of the genomic sequence file is not retrieved.

In block 403, a portion of the genomic sequence file is written into memory. In some embodiments, a URL to the genomic sequence file is written into memory, and a portion of the genomic sequence file accessed at the URL is written into memory (for example, nonvolatile memory). In some embodiments, the portion of the genomic sequence file accessed at the URL and written into memory comprises genomic sequence data located within the byte range of block 402, and in exemplary embodiments, the portion of the genomic sequence file accessed at the URL and written into memory comprises a header and genomic sequence data located within the byte range of block 402. Thus, in some embodiments, a process comprises writing into the memory a URL to the genomic sequence file and transferring into memory (for example, nonvolatile memory) a portion of the genomic sequence file accessed at the URL, wherein the portion comprises genomic sequence data. The portion of the genomic sequence data that is written into memory will generally be greater than or equal to 1 byte but less than the entirety of the genomic data. In some embodiments, a portion of the genomic sequence file is written into nonvolatile memory.

In some embodiments, one or more portions of the genomic sequence file is retrieved using an asynchronous I/O library. The same functions used in writing the first index into memory can also be used to write portions of the genomic sequence file. Thus, exemplary libraries include libuv.

In some embodiments, a second genomic sequence file is generated. The second genomic sequence file will generally comprise various portions of an original or first genomic sequence file, such portions including any combination of some or all of the header, some or all of the genomic sequence data and some or all of the end-of-file marker. In exemplary embodiments, the second genomic sequence file comprises a header and genomic sequence data. In some embodiments, the second genomic sequence file comprises a header, genomic sequence data and an end-of-file marker. In some embodiments, the second genomic sequence file comprises genomic sequence data. It may be advantageous to avoid decompression and recompression of first genomic sequence file. Thus, the various portions of a first or original genomic sequence file can be retrieved and, without decompression, assembled into the second genomic sequence file. In exemplary embodiments, no portion of the first genomic sequence file is decompressed. In exemplary embodiments, the header is not decompressed. In exemplary embodiments, the genomic sequence data are not decompressed. In exemplary embodiments, no portion of the header or genomic sequence data is decompressed.

In some embodiments, memory (such as nonvolatile memory) is preallocated for the second genomic sequence file.

In some embodiments, the second genomic sequence file is not a proper compressed file. In these embodiments, the second genomic sequence file cannot be linearly decompressed using the compression algorithm that generated the original file whose portions were used to assemble the second genomic sequence file.

In block 404, a second index is calculated. Because only a subset of the first genomic sequence file will have been retrieved, a second index different from the first index is needed in order to use such subset. Using the first index as a template to generate a second index, all reference sequences outside of the genomic range can be deleted. Thus, only a subset of the chunks described in the first index will need to be retained in many cases.

When calculating a second index for use with a second genomic sequence file, the virtual file offsets of the start and end points of each chunk also need to be adjusted to reflect their locations in a second genomic sequence file. Each start and end point is bit-shifted right by the bit-length of the maximum uncompressed offset and then the first-block offset is subtracted. The bits representing the uncompressed offset are then appended to this new value to produce a new start and end point. This process is repeated for each chunk of each reference sequence that is to be retained. The first-block offset is also used in a similar manner to adjust the locations of the first alignment contained in each interval of the linear index.

In block 405, the second index is written into memory. In some embodiments, the second index is written into nonvolatile memory.

One of skill in the art will appreciate that in some embodiments, the steps or operations described herein, such as shown in FIG. 4, may be arranged in a different order. For example, in some embodiments, after block 402 where a byte range of the genomic sequence file has been calculated, block 404 (calculating a second index) and block 405 (writing the second index into memory) can take place before block 403 (writing into memory a portion of the genomic sequence file). Certain steps or operations described sequentially may in some cases be performed concurrently. In some of these various embodiments, the genomic sequence file is compressed and no portion thereof is decompressed in performing the process. In exemplary embodiments, genomic sequence data are compressed and no portion thereof is decompressed in performing the process.

In some embodiments, the information or data in a second index and in a second genomic sequence file are passed to one or more downstream algorithms or software for additional processing. The second genomic sequence file contains genomic sequences that have been aligned to a certain position in the reference sequence. Various other analyses known in the art can be performed to extract additional information from the second genomic sequence file. For example, it may be useful to determine if the alignments indicate a variant with respect to a reference sequence. Thus, in some embodiments, the second genomic sequence file is passed as input to variant call software. In some embodiments, the second genomic sequence file and the second index are passed as input to variant call software. Many variant call algorithms and software are known in the art. Examples include CRISP, GATK, SAMtools, SNVer, SomaticSniper, CNVnator, RDXplorer, CONTRA ExomeCNV, BreakDancer, Breakpointer, CLEVER, GASVPro and SVMerge. In exemplary embodiments, the variant call software is GATK (HaplotypeCaller). The downstream algorithm or software could employ a method for parallel processing of the files. Thus, in some embodiments, one or more executions of the variant call software are simultaneously initiated, wherein each execution uses one or more threads. In some embodiments, each of the executions is run on a separate cloud instance. Other types of analysis that might be performed on the information or data in the second index and second genomic sequence file include multi-sample processing, annotation and filtering of variants, data aggregation, association analysis, population structure analysis and visualization, among others.

Any of the disclosed operations, combinations of operations or methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a customer-server network (such as a cloud computing network), or other such network) using one or more network computers.

It should be understood that the disclosed technology is not limited to any specific computer language or program. For instance, the disclosed technology can be implemented by software written in C, C++, Java, Perl, JavaScript or any other suitable programming language. Likewise, the disclosed technology is not limited to any particular computer or type of hardware. Certain details of suitable computers and hardware are well known in the art.

It should also be well understood that any functionality described herein can be performed, at least in part, by one or more hardware logic components, instead of software. For example, and without limitation, illustrative types of hardware logic components that can be used include field-programmable gate arrays (FPGAs), program-specific integrated circuits (ASICs), program-specific standard products (ASSPs), system-on-a-chip systems (SOCs), complex programmable logic devices (CPLDs), etc.

### EXAMPLES

### Example 1

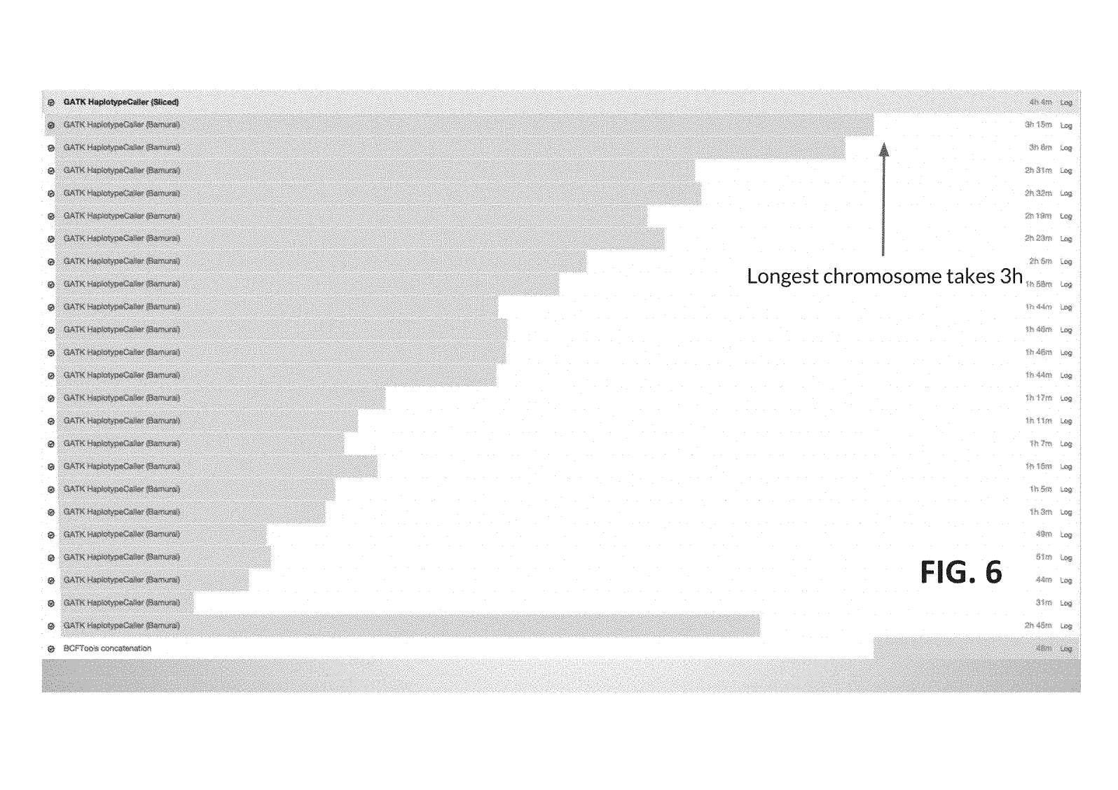

FIG. 6 shows the time savings gained by utilizing the systems and processes described herein. GATK HaplotypeCaller was run on files produced by a system described herein and on BAM files that were sliced by Sambamba Slice. As shown in FIG. 6, the presently described system finished processing the largest reference sequence in 3 hours and 15 minutes, compared to about 4 hours using files produced by Sambamba Slice.

The articles “a,” “an” and “the” as used herein do not exclude a plural number of the referent, unless context clearly dictates otherwise. The conjunction “or” is not mutually exclusive, unless context clearly dictates otherwise. The term “include” refers to nonexhaustive examples.

All references, publications, patent applications, issued patents, records, databases, websites and urls cited herein are incorporated by reference in their entirety for all purposes.

We claim:

1. A system comprising a memory and a processor coupled to the memory, wherein the memory comprises program instructions executable by the processor to:
(a) write into the memory a first index comprising one or more locations of a genomic sequence file comprising a header and genomic sequence data;
(b) calculate, based on the first index and a genomic range, a byte range of the genomic sequence file;
(c) write into the memory a portion of the genomic sequence file, wherein the portion comprises genomic sequence data located within the byte range;
(d) calculate a second index; and
(e) write into the memory the second index,
wherein the genomic sequence data are compressed and no portion of the genomic sequence data is decompressed.

2. The system of claim 1, wherein the memory further comprises program instructions executable by the processor to (a) write into the memory a URL to the genomic sequence file and (b) transfer into the memory a portion of the genomic sequence file accessed at the URL, wherein the portion comprises genomic sequence data.

3. The system of claim 2, wherein a plurality of simultaneous connections between a local computer and a remote computer is utilized for transferring the portion of the genomic sequence file accessed at the URL.

4. The system of claim 1, wherein the genomic sequence file is stored in an object store.

5. The system of claim 1, wherein the first index comprises a virtual file offset of one or more chunks of alignments, and wherein the memory further comprises program instructions executable by the processor to adjust the virtual file offset of at least one of the chunks.

6. The system of claim 1, wherein the memory further comprises program instructions executable by the processor to generate a second genomic sequence file comprising the header and the portion of the genomic sequence file comprising genomic sequence data.

7. The system of claim 6, wherein no portion of the header or the genomic sequence data is decompressed.

8. The system of claim 6, wherein the memory further comprises program instructions executable by the processor to pass the data of the second genomic sequence file and the second index as input to variant call software.

9. The system of claim 8, wherein the memory further comprises program instructions executable by the processor to initiate one or more executions of the variant call software, wherein each execution uses one or more threads.

10. The system of claim 9, wherein each of the executions is run on a separate cloud instance.

11. The system of claim 6, wherein the memory further comprises program instructions executable by the processor to preallocate space in the memory for the second genomic sequence file.

12. The system of claim 1, wherein the genomic range consists of whole contiguous reference sequences.

13. A method of processing a genomic sequence file in a computer, wherein the genomic sequence file comprises a header and genomic sequence data; and wherein the computer comprises a memory and a processor, the method comprising:
(a) writing into the memory a first index comprising one or more locations of the genomic sequence file;
(b) calculating, based on the first index and a genomic range, a byte range of the genomic sequence file;
(c) writing into the memory a portion of the genomic sequence file, wherein the portion comprises genomic sequence data located within the byte range;
(d) calculating a second index; and
(e) writing into the memory the second index,
wherein the genomic sequence data are compressed and no portion of the genomic sequence data is decompressed.

14. The method of claim 13, further comprising (a) writing into the memory a URL to the genomic sequence file and (b) transferring into the memory a portion of the genomic sequence file accessed at the URL, wherein the portion comprises genomic sequence data.

15. The method of claim 14, wherein a plurality of simultaneous connections between a local computer and a remote computer is utilized for transferring the portion of the genomic sequence file accessed at the URL.

16. The method of claim 13, wherein the genomic sequence file is stored in an object store.

17. The method of claim 13, wherein the first index comprises a virtual file offset of one or more chunks of alignments, and wherein the method further comprises adjusting the virtual file offset of at least one of the chunks.

18. The method of claim 13, further comprising generating a second genomic sequence file comprising the header and the portion of the genomic sequence file comprising genomic sequence data.

19. The method of claim 18, wherein no portion of the header or the genomic sequence data is decompressed.

20. The method of claim 18, further comprising passing the data of the second genomic sequence file and the second index as input to variant call software.

21. The method of claim 20, further comprising initiating one or more executions of the variant call software, wherein each execution uses one or more threads.

22. The method of claim 21, wherein each of the executions is run on a separate cloud instance.

23. The method of claim 18, further comprising preallocating space in the memory for the second genomic sequence file.

24. The method of claim 13, wherein the genomic range consists of whole contiguous reference sequences.
